(19) United States
(12) Patent Application Publication
(10) Pub. No.: US 2014/0218411 A1
(43) Pub. Date: Aug. 7, 2014

(54) Method and System for Improving a Color Shift of Viewing Angle of Skin Color of an LCD Screen

(71) Applicants: Lixuan Chen, Shenzhen City (CN); Chih-tsung Kang, Shenzhen City (CN)

(72) Inventors: Lixuan Chen, Shenzhen City (CN); Chih-tsung Kang, Shenzhen City (CN)

(73) Assignee: Shenzhen China Star Optoelectronics Technology Co. Ltd., Shenzhen, Guangdong (CN)

(21) Appl. No.: 13/818,986

(22) PCT Filed: Feb. 19, 2013
(86) PCT No.: PCT/CN13/71668

§ 371 Date: Feb. 25, 2013

(30) Foreign Application Priority Data
Feb. 5, 2013 (CN) 201310046306.6

(51) Int. Cl. G09G 3/36

(52) U.S. Cl. CPC G09G 3/36
USPC 345/690; 345/88

(57) ABSTRACT

The present invention discloses a method and system for improving a color shift of viewing angle of skin color of an LCD screen. The method comprises: comparing the gamma curves and the chromaticity of 0-255 grayscale of front viewing angle and oblique viewing angle of red (R), green (G), and blue (B) after adjusting according to the initial white balance voltage and changing the voltage dividing proportion of the blue-white-balance (BWB) voltage according to the color shift result to make a color shift value of oblique viewing angle of skin color picture of the LCD screen be always within a specification requirement. Through foregoing method, the present invention makes the color shift of skin color of viewing angle of the LCD screen is always within the specification requirement.

### BACKGROUND OF THE INVENTION

1. Field of the Invention

The present invention relates to the field of display technology, and more particularly to a method and system for improving a color shift of viewing angle of skin color of an LCD screen.

2. Description of Related Art

Currently, the liquid crystal cell of the liquid crystal display (LCD) screen includes a red, a green and a blue color films having different thickness and the thickness of the blue color film is thicker than the thickness of the red and the green color films. Therefore, the thickness of the liquid crystal corresponding to the blue color film is smaller than the thickness of the liquid crystal corresponding to the red and green color films. This design leads to the inversion of Z of the tristimulus values of the blue color. With reference to FIG. 1, which is a relationship diagram of the tristimulus values of blue versus voltage, wherein, the Z occurs inversion at high voltage. This leads to the color shift of the LCD screen.

Currently, the TV manufacturer often judges the quality of the LCD screen according to the deviation between the chromaticity of oblique viewing angle and the chromaticity of front viewing angle of the LCD screen and to the chromaticity of the white point. In the LCD module design, the small and medium size products usually do not use the low color shift design, and thus, the color shift testing result of oblique viewing angle of the LCD screen is usually beyond the TV manufacturer's specification.

### SUMMARY OF THE INVENTION

The technical problem solved by the present invention is to provide method and system for improving a color shift of viewing angle of skin color of an LCD screen such that a color shift result of viewing angle of skin color of the LCD screen is always within a TV manufacturer's specification requirement.

In order to solve the above-mentioned technical problem, a technical solution provided by the present invention is: a method for improving a color shift of viewing angle of skin color of an LCD screen, the method comprising: obtaining gamma curves of red (R), green (G), blue (B) and white (W) of front viewing angle of skin color picture of the LCD screen under a backlight; calculating an initial white balance voltage, the initial white balance voltage includes a red-white-balance (RWB) voltage, a green-white-balance (GWB) voltage and a blue-white-balance (BWB) voltage, and adjusting the gamma curves of red (R), green (G) and blue (B) of skin color picture of the LCD screen according to the initial white balance voltage; obtaining gamma curves of red (R), green (G), blue (B) and white (W) of front viewing angle and oblique viewing angle of skin color picture of the LCD screen after adjusting according to the initial white balance voltage; comparing the gamma curves and the chromaticity of 0-255 grayscale of front viewing angle and oblique viewing angle to obtain a color shift result of oblique viewing angle of skin color picture of the LCD screen; and changing a voltage dividing proportion of the blue-white-balance (BWB) voltage according to the color shift result to make a color shift value of oblique viewing angle of skin color picture of the LCD screen be always within a specification requirement; wherein, the specification requirement is a color difference specification requirement between the front viewing angle and the oblique viewing angle, and the color difference specification requirement is that the color shift value of oblique viewing angle is within (−0.03, +0.03).

Wherein, the step of changing a voltage dividing proportion of the blue-white-balance (BWB) voltage according to the color shift result to make a color shift value of oblique viewing angle of skin color picture of the LCD screen be always within a specification requirement further comprises: if the color shift value of oblique viewing angle is less than −0.03, increasing the voltage dividing proportion of the blue-white-balance (BWB) voltage; and if the color shift value of oblique viewing angle is greater than +0.03, decreasing the voltage dividing proportion of the blue-white-balance (BWB) voltage.

Wherein, the blue-white-balance (BWB) voltage at 255th grayscale ranges from 4.5V to 7.1V.

In order to solve the above-mentioned technical problem, another technical solution provided by the present invention is: a method for improving a color shift of viewing angle of skin color of an LCD screen, the method comprising: obtaining gamma curves of red (R), green (G), blue (B) and white (W) of front viewing angle of skin color picture of the LCD screen under a backlight; calculating an initial white balance voltage, the initial white balance voltage includes a red-white-balance (RWB) voltage, a green-white-balance (GWB) voltage and a blue-white-balance (BWB) voltage, and adjusting the gamma curves of red (R), green (G) and blue (B) of skin color picture of the LCD screen according to the initial white balance voltage; obtaining gamma curves of red (R), green (G), blue (B) and white (W) of front viewing angle and oblique viewing angle of skin color picture of the LCD screen after adjusting according to the initial white balance voltage; comparing the gamma curves and the chromaticity of 0-255 grayscale of front viewing angle and oblique viewing angle to obtain a color shift result of oblique viewing angle of skin color picture of the LCD screen; and changing a voltage dividing proportion of the blue-white-balance (BWB) voltage according to the color shift result to make a color shift value of oblique viewing angle of skin color picture of the LCD screen be always within a specification requirement.

Wherein, the step of changing a voltage dividing proportion of the blue-white-balance (BWB) voltage according to the color shift result to make a color shift value of oblique viewing angle of skin color picture of the LCD screen be always within a specification requirement further comprises: maintaining the red-white-balance (RWB) voltage and the green-white-balance (GWB) voltage to be constant, changing the voltage dividing proportion of the blue-white-balance (BWB) voltage according to the color shift result to obtain a new white balance voltage; and in the new white balance voltage, further obtaining a color shift result of oblique viewing angle of skin color picture of the LCD screen, and determining if the color shift result deviates from the specification requirement.

Wherein, the specification requirement is a color difference specification requirement between the front viewing angle and the oblique viewing angle, and the color difference specification requirement is that the color shift value of oblique viewing angle is within (−0.03, +0.03).

Wherein, the step of changing a voltage dividing proportion of the blue-white-balance (BWB) voltage according to the color shift result to make a color shift value of oblique viewing angle of skin color picture of the LCD screen be always within a specification requirement further comprises: if the color shift value of oblique viewing angle is less than −0.03, increasing the voltage dividing proportion of the blue-white-balance (BWB) voltage; and if the color shift value of oblique viewing angle is greater than +0.03, decreasing the voltage dividing proportion of the blue-white-balance (BWB) voltage.

Wherein, the blue-white-balance (BWB) voltage at 255th grayscale ranges from 4.5V to 7.1V.

In order to solve the above-mentioned technical problem, another technical solution provided by the present invention is: A system for improving a color shift of viewing angle of skin color of an LCD screen, wherein, the system comprises a gamma curve acquisition unit, an adjustment unit, a comparing unit, and a voltage-dividing unit, wherein the gamma curve acquisition unit obtains gamma curves of red (R), green (G), blue (B) and white (W) of front viewing angle of skin color picture of the LCD screen under a backlight; wherein the adjustment unit for calculates an initial white balance voltage, the initial white balance voltage includes a red-white-balance (RWB) voltage, a green-white-balance (GWB) voltage and a blue-white-balance (BWB) voltage, and adjusting the gamma curves of red (R), green (G) and blue (B) of skin color picture of the LCD screen according to the initial white balance voltage; wherein the gamma curve acquisition unit obtains gamma curves of red (R), green (G), blue (B) and white (W) of front viewing angle and oblique viewing angle of skin color picture of the LCD screen after adjusting according to the initial white balance voltage; wherein the comparing unit compares the gamma curves and the chromaticity of 0-255 grayscale of front viewing angle and oblique viewing angle to obtain a color shift result of oblique viewing angle of skin color picture of the LCD screen; and wherein the voltage-dividing unit changes a voltage dividing proportion of the blue-white-balance (BWB) voltage according to the color shift result to make a color shift value of oblique viewing angle of skin color picture of the LCD screen be always within specification requirement.

Wherein, the voltage-dividing unit further comprises a red-voltage-dividing unit, a green-voltage-dividing unit, and a blue-voltage-dividing unit, wherein, the red-voltage-dividing unit and the green-voltage-dividing unit respectively maintain the red-white-balance (RWB) voltage and the green-white-balance (RWB) voltage to be constant, and the blue-voltage-dividing unit correspondingly changes the voltage dividing proportion of the blue-white-balance (BWB) voltage according to the specification requirement in order to obtain a new white balance voltage; wherein at the new white balance voltage, the comparing unit further obtains a color shift result of oblique viewing angle of skin color picture of the LCD screen to determine if the color shift result deviates from the specification requirement; and wherein if the color shift result deviates from the specifications, the blue-voltage-dividing unit repeatedly change the voltage dividing proportion of the blue-white-balance (BWB) voltage until at a new white balance voltage, the color shift value of oblique viewing angle of skin color picture of the LCD screen is always within specification requirement.

Wherein, the specification requirement is a color difference specification requirement between the front viewing angle and the oblique viewing angle, and the color difference specification requirement is that the color shift value of Oblique viewing angle is within (−0.03, +0.03).

Wherein, when the color shift value of oblique viewing angle is less than −0.03 the blue-voltage-dividing unit changes the blue-white-balance (BWB) voltage such that the voltage dividing proportion of the blue-white-balance (BWB) voltage becomes larger; and when the color shift value of oblique viewing angle is greater than +0.03, the blue-voltage-dividing unit changes the blue-white-balance (BWB) voltage such that the voltage dividing proportion of the blue-white-balance (BWB) voltage becomes smaller.

Wherein, the blue-white-balance (BWB) voltage at 255th grayscale ranges from 4.5V to 7.1V.

The beneficial effects of the present invention are: compared to the prior art, the present invention the present invention compares the gamma curves and the chromaticity of 0-255 grayscale of front viewing angle and oblique viewing angle of red (R), green (G), blue (B) and white (W) of the traditional with balance to obtain a color shift result of oblique viewing angle of skin color picture of the LCD screen and changes the voltage dividing proportion of the blue-white-balance (BWB) voltage according to the color shift result to make a color shift value of oblique viewing angle of skin color picture of the LCD screen be always within a specification requirement.

Through foregoing method, the present invention makes the color shift of skin color of viewing angle of the LCD screen is always within the specification requirement of the TV manufacturer.

### BRIEF DESCRIPTION OF THE DRAWINGS

FIG. 1 is a relationship diagram of tristimulus values of blue color versus voltage;

FIG. 2 is a flowchart of a method for improving a color shift of viewing angle of skin color of the LCD screen according to an embodiment of the present invention;

FIG. 3 is a relationship diagram of color shift versus viewing angle;

FIG. 4 is a relationship diagram of a color shift of oblique viewing angle versus voltage in a color difference specification requirement;

FIG. 5 is flowchart of changing a voltage dividing proportion of a blue-white-balance (BWB) voltage according to the color shift result; and

FIG. 6 is a schematic diagram of a system for improving a color shift of viewing angle of skin color of LCD screen according to an embodiment of the present invention.

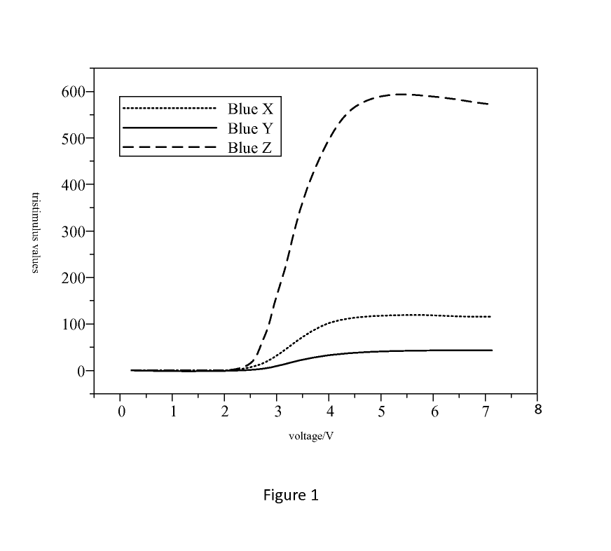

### DETAILED DESCRIPTION OF THE PREFERRED EMBODIMENT

The following content combines with the drawings and the embodiment for describing the present invention in detail.

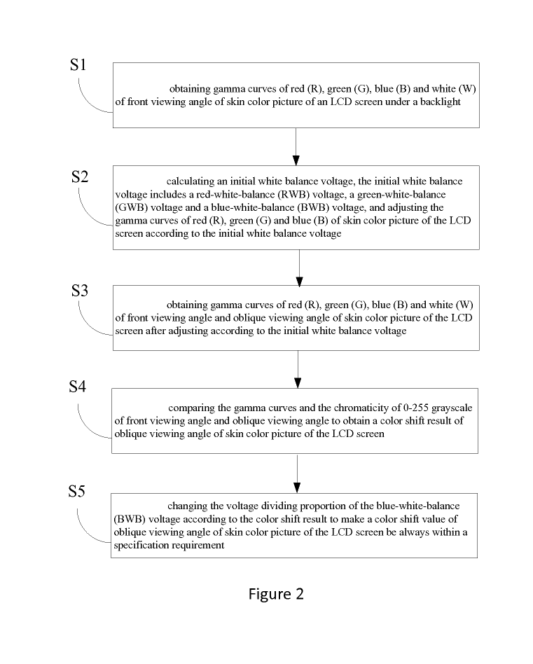

With reference FIG. 2, this is a flowchart of a method for improving a color shift of viewing angle of skin color of the LCD screen according to an embodiment of the present invention. As shown in FIG. 2, the method includes the following steps:

Step S1: obtaining gamma curves of red (R), green (G), blue (B) and white (W) of front viewing angle of skin color picture of an LCD screen under a backlight.

In step S1, it specifically obtains the brightness and chromaticity of red (R), green (G), blue (B) and white (W) of front viewing angle of skin color picture of the LCD screen under the backlight corresponding to 0 to 255 grayscale in order to obtain the corresponding gamma curves. Wherein in the present embodiment, the backlight is preferably selected as a backlight of China Star Optoelectronics Technology (CSOT), and the gamma value is preferably selected as 2.2.

Step S2: calculating an initial white balance voltage, the initial white balance voltage includes a red-white-balance (RWB) voltage, a green-white-balance (GWB) voltage and a blue-white-balance (BWB) voltage, and adjusting the gamma curves of red (R), green (G) and blue (B) of skin color picture of the LCD screen according to the initial white balance voltage.

In step S2, firstly determining the chromaticity of white (W) to be x, y, usually in the CSOT backlight, the chromaticity of white (W) of the LCD screen is x=0.28, y=0.29. Therefore, it designs the chromaticity of each grayscale near that value and maintains the value of the gamma curve around 2.2. In this embodiment, at the initial white balance voltage, the voltage ranges of the red-white-balance (RWB) voltage, the green-white-balance (GWB) voltage and the blue-white-balance (BWB) voltage at 255th grayscale all locate from 7.0V to 7.1V.

Step S3: obtaining gamma curves of red (R), green (G), blue (B) and white (W) of front viewing angle and oblique viewing angle of skin color picture of the LCD screen after adjusting according to the initial white balance voltage.

Step S4: comparing the gamma curves and the chromaticity of 0-255 grayscale of front viewing angle and oblique viewing angle to obtain a color shift result of oblique viewing angle of skin color picture of the LCD screen.

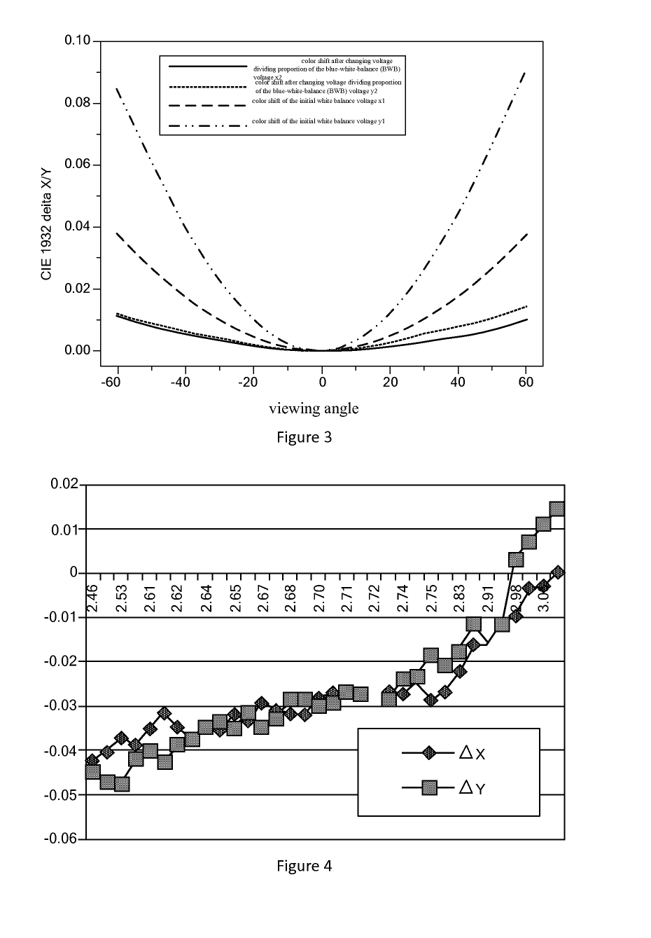

In step S4, the color shift result of oblique viewing angle of skin color picture of the LCD screen after adjusting according to the initial white balance voltage can refer to FIG. 3, which is a relationship diagram of color shift versus viewing angle. As shown in FIG. 3, x1 and y1 are the color shift result of skin color picture of the LCD screen after adjusting according to the initial white balance voltage.

Step S5: changing the voltage dividing proportion of the blue-white-balance (BWB) voltage according to the color shift result to make a color shift value of oblique viewing angle of skin color picture of the LCD screen be always within a specification requirement.

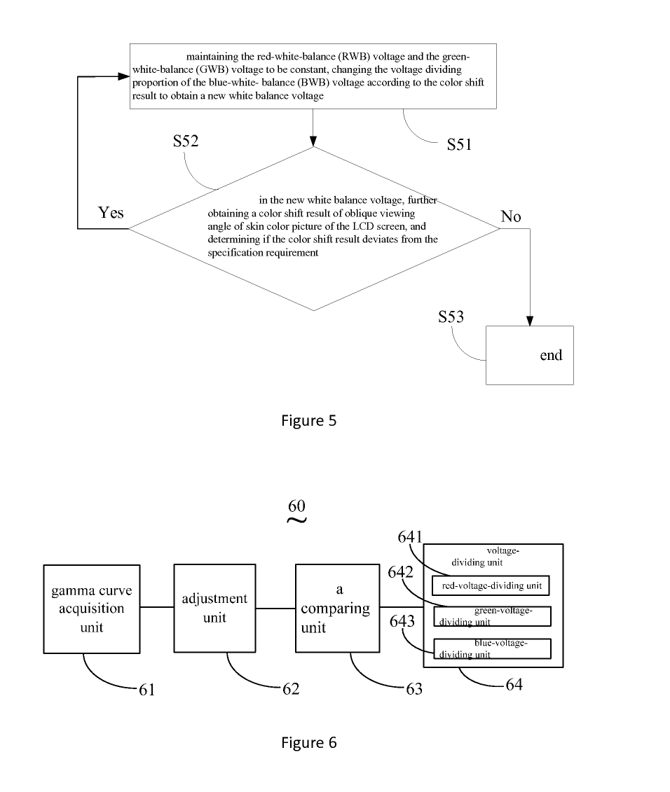

In step S5, the specification requirement of the present embodiment is a color difference specification requirement between the front viewing angle and the oblique viewing angle. And the color difference specification requirement is that a color shift value oblique viewing angle is within (−0.03, +0.03). With reference to FIG. 4, which is a relationship diagram of a color shift of oblique viewing angle versus voltage in a color difference specification requirement, wherein, when the color shift values (Δx, Δy) are within the range of (−0.03, +0.03), it judges that the color shift of oblique viewing angle of skin color picture of the LCD screen does not deviate from a preset specification requirement; when the color shift value (Δx, Δy) shown in FIG. 4 are beyond the range of (−0.03, +0.03), judges that it deviates from the preset specification requirement. In that situation, it requires changing voltage dividing proportion of the white balance voltage of the blue color. Wherein, the specific step for changing the voltage dividing proportion of the blue-white-balance (BWB) voltage is shown in FIG. 5. It is a flowchart of changing a voltage dividing proportion of a blue-white-balance (BWB) voltage according to the color shift result. The specific steps comprise:

Step S51: maintaining the red-white-balance (RWB) voltage and the green-white-balance (GWB) voltage to be constant, changing the voltage dividing proportion of the blue-white-balance (BWB) voltage according to the color shift result to obtain a new white balance voltage.

In step S51, with further reference to FIG. 4, if color shift value of oblique viewing angle is less than −0.03, increasing the voltage dividing proportion of the blue-white-balance (BWB) voltage; if a color shift value of oblique viewing angle is greater than +0.03, decreasing the voltage dividing proportion of the blue-white-balance (BWB) voltage. Wherein, in the present embodiment, the blue-white-balance (BWB) voltage at 255th grayscale ranges from 4.5V to 7.1V.

Step S52: In the new white balance voltage, further obtaining a color shift result of oblique viewing angle of skin color picture of the LCD screen, and determining if the color shift result deviates from the specification requirement.

In step S52, if a determining result is YES, jumping to step S51, that is, repeatedly changing the voltage dividing proportion of the blue-white-balance (BWB) voltage until in the new white balance voltage, the color shift value of oblique viewing angle of skin color picture of the LCD screen is always within the specification requirement shown in FIG. 4. In the present embodiment, after changing the blue-white-balance (BWB) voltage according to the specification requirement shown in FIG. 4, the color shift result is shown in FIG. 3, wherein, x2 and y2 are the color shift values after changing the white balance voltage of blue color. With reference to FIG. 3 and FIG. 4, the higher blue-white-balance (BWB) voltage, the smaller color shift.

If the determining result is NO, jumping to step S53.

Step S53 end.

With reference to FIG. 6, this is a schematic diagram of a system for improving a color shift of viewing angle of skin color of the LCD screen according to an embodiment of the present invention. As show FIG. 6, the system 60 for improving the color shift of skin color of viewing angle of the LCD screen of the present invention includes a gamma curve acquisition unit 61, an adjustment unit 62, a comparing unit 63, and a voltage-dividing unit 64.

Wherein, the gamma curve acquisition unit 61 obtains gamma curves of red (R), green (G), blue (B), and white (W) of front viewing angle of skin color picture of an LCD screen under a backlight.

Specifically, the gamma curve acquisition unit 61 is for obtaining the brightness and chromaticity of red (R), green (G), blue (B) and white (W) of skin color picture of front viewing angle of the LCD screen under the backlight corresponding to 0 to 255 grayscale in order to obtain the corresponding gamma curves. Wherein, in the present embodiment, the backlight is preferably selected as a backlight of China Star Optoelectronics Technology (CSOT), and the gamma value is preferably selected as 2.2.

The adjustment unit 62 calculates an initial white balance voltage, the initial white balance voltage, includes a red-white-balance (RWB) voltage, a green-white-balance (GWB) voltage and a blue-while-balance (BWB) voltage, and adjusting the gamma curves of red (R), green (CO and blue (B) of skin color picture of the LCD screen according to the initial white balance voltage.

Specifically, the adjustment unit 62 firstly determines the chromaticity of white (W) to be x, y. In the CSOT backlight, usually, the chromaticity of white (W) of the LCD screen is x=0.28, y=0.29. Therefore, it designs the chromaticity of each grayscale near that value and maintains the value of the gamma curve around 2.2. In this embodiment, at the initial white balance voltage, the voltage ranges of the red-white-balance (RWB) voltage, the green-white-balance (GWB) voltage and the blue-white-balance (BWB) voltage at 255th grayscale all locate from 7.0V to 7.1V.

The gamma curve acquisition unit 61 obtains gamma curves of red (R), green (G), blue (B) and white (W) of front viewing angle and oblique viewing angle of skin color picture of the LCD screen after adjusting according to the initial white balance voltage. The comparing unit 63 compares the gamma curves and the chromaticity of 0-255 grayscale of front viewing angle and oblique viewing angle to obtain a color shift result of oblique viewing angle of skin color picture of the LCD screen.

Wherein, the color shift result of skin color picture of the LCD screen after adjusting according to the initial white balance voltage is x1 and y1 as shown in FIG. 3. The specification requirement of the present embodiment is the color difference specification requirement of front viewing angle and oblique viewing angle. And the color difference specification requirement is that a color shift value of oblique viewing angle is within (−0.03, +0.03). It is specifically shown in FIG. 4.

The present embodiment, if the comparing result of the comparison unit 63 is that the color shift values (Δx, Δy) of an oblique value shown in FIG. 4 are within the range of (−0.03, +0.03), it judges that the color shift of oblique viewing angle of skin color picture of the LCD screen does not deviate from the preset specification requirement; when color shift values (Δx, Δy) of an oblique value shown in FIG. 4 is beyond the range of (−0.03, +0.03), it judges that the color shift of oblique viewing angle of skin color picture of the LCD screen deviate from the specification requirement.

The voltage-dividing unit 64 changes the voltage dividing proportion of the blue-white-balance (BWB) voltage according to the color shift result to make a color shift value of oblique viewing angle of skin color picture of the LCD screen be always within the specification requirement. Specifically, the voltage-dividing unit 64 comprises a red-voltage-dividing unit 641, a green-voltage-dividing unit 642, and a blue-voltage-dividing unit 643, wherein, the red-voltage-dividing unit 641 and the green-voltage-dividing unit 642 respectively maintain the red-white-balance (RWB) voltage and the green-white-balance (RWB) voltage to be constant. The blue-voltage-dividing unit 643 correspondingly changes the voltage dividing proportion of the blue-white-balance (BWB) voltage according to the specification requirement in order to obtain a new white balance voltage. Specifically, when the color shift value of oblique viewing angle is less than −0.03, the blue-voltage-dividing unit 643 changes the blue-white-balance (BWB) voltage such that the voltage dividing proportion of the blue-white-balance (BWB) voltage becomes larger. When the color shift value of oblique viewing angle is greater than +0.03, the blue-voltage-dividing unit 643 changes the blue-white-balance (BWB) voltage such that the voltage dividing proportion of the blue-white-balance (BWB) voltage becomes smaller.

At the new white balance voltage, the comparing unit 63 further obtains a color shift result of oblique viewing angle of skin color picture of the LCD screen to determine if the color shift result deviates from the specification requirement. If the color shift result deviates from the specifications, the blue-voltage-dividing unit 643 repeatedly change the voltage dividing proportion of the blue-white-balance (BWB) voltage until at a new white balance voltage, the color shift value of oblique viewing angle of skin color picture of the LCD screen is always within specification requirement.

In this embodiment, when the blue-white-balance (BWB) voltage is changed the blue-white-balance (BWB)) voltage of the 255th grayscale ranges from 4.5V to 7.1V.

In summary, the present invention compares the gamma curves and the chromaticity of 0-255 grayscale of front viewing angle and oblique viewing angle of red (R), green (G), blue (B) and white (W) of the traditional with balance to obtain a color shift result of oblique viewing angle of skin color picture of the LCD screen and changes the voltage dividing proportion of the blue-white-balance (BWB) voltage according to the color shift result to make a color shift value of oblique viewing angle of skin color picture or the LCD screen be always within a specification requirement.

Through foregoing method, the present invention makes the color shift of skin color of viewing angle of the LCD screen is always within the specification requirement of the TV manufacturer.

The above embodiments of the present invention are not used to limit the claims of this invention. Any use of the content in the specification or in the drawings of the present invention which produces equivalent structures or equivalent processes, or directly or indirectly used in other related technical fields is still covered by the claims in the present invention.

What is claimed is:

1. A method for improving a color shift of viewing angle of skin color of an LCD screen, the method comprising:
obtaining gamma curves of red (R), green (G), blue (B) and white (W) of front viewing angle of skin color picture of the LCD screen under a backlight;
calculating an initial white balance voltage, the initial white balance voltage includes a red-white-balance (RWB) voltage, a green-white-balance (GWB) voltage and a blue-white-balance (BWB) voltage, and adjusting the gamma curves of red (R), green (G) and blue (B) of skin color picture of the LCD screen according to the initial white balance voltage;
obtaining gamma curves of red (R), green (G), blue (B) and white (W) of front viewing angle and oblique viewing angle of skin color picture of the LCD screen after adjusting according to the initial white balance voltage;
comparing the gamma curves and the chromaticity of 0-255 grayscale of front viewing angle and oblique viewing angle to obtain a color shift result of oblique viewing angle of skin color picture of the LCD screen; and
changing a voltage dividing proportion of the blue-white-balance (BWB) voltage according to the color shift result to make a color shift value of oblique viewing angle of skin color picture of the LCD screen be always within a specification requirement;
wherein, the specification requirement is a color difference specification requirement between the front viewing angle and the oblique viewing angle, and the color difference specification requirement is that the color shift value of oblique viewing angle is within (−0.03, +0.03).

2. The method according to claim 1, wherein, the step of changing a voltage dividing proportion of the blue-white-balance (BWB) voltage according to the color shift result to make a color shift value of oblique viewing angle of skin color picture of the LCD screen be always within a specification requirement further comprises:
if the color shift value of oblique viewing angle is less than −0.03, increasing the voltage dividing proportion of the blue-white-balance (BWB) voltage; and
if the color shift value of oblique viewing angle is greater than +0.03, decreasing the voltage dividing proportion of the blue-white-balance (BWB) voltage.

3. The method according to claim 1, wherein, the blue-white-balance (BWB) voltage at 255th gray ranges from 4.5V to 7.1V.

4. A method for improving a color shift of viewing angle of skin color of an LCD screen, the method comprising:
obtaining gamma curves of red (R), green (G), blue (B) and white (W) of front viewing angle of skin color picture of the LCD screen under a backlight;
calculating an initial white balance voltage, the initial white balance voltage includes a red-white-balance (RWB) voltage, a green-white-balance (GWB) voltage and a blue-white-balance (BWB) voltage, and adjusting the gamma curves of red (R), green (G) and blue (B) of skin color picture of the LCD screen according to the initial white balance voltage;
obtaining gamma curves of red (R), green (G), blue (B) and white (W) of front viewing angle and oblique viewing angle of skin color picture of the LCD screen after adjusting according to the initial white balance voltage;
comparing the gamma curves and the chromaticity of 0-255 grayscale of front viewing angle and oblique viewing angle to obtain a color shift result of oblique viewing angle of skin color picture of the LCD screen; and
changing a voltage dividing proportion of the blue-white-balance (BWB) voltage according to the color shift result to make a color shift value of oblique viewing angle of skin color picture of the LCD screen be always within a specification requirement.

5. The method according to claim 4, wherein, the step of changing a voltage dividing proportion of the blue-white-balance (BWB) voltage according to the color shift result to make a color shift value of oblique viewing angle of skin color picture of the LCD screen be always within a specification requirement further comprises:
maintaining the red-white-balance (RWB) voltage and the green-white-balance (GWB) voltage to be constant, changing the voltage dividing proportion of the blue-white-balance (BWB) voltage according to the color shift result to obtain a new white balance voltage; and
in the new white balance voltage, further obtaining a color shift result of oblique viewing angle of skin color picture of the LCD screen, and determining if the color shift result deviates from the specification requirement.

6. The method according to claim 4, wherein, the specification requirement is a color difference specification requirement between the front viewing angle and the oblique viewing angle, and the color difference specification requirement is that the color shift value of oblique viewing angle is within (−0.03, +0.03).

7. The method according to claim 6, wherein, the step of changing a voltage dividing proportion of the blue-white-balance (BWB) voltage according to the color shift result to make a color shift value of oblique viewing angle of skin color picture of the LCD screen be always within a specification requirement further comprises:
if the color shift value of oblique viewing angle is less than −0.03, increasing the voltage dividing proportion of the blue-white-balance (BWB) voltage; and
if the color shift value of oblique viewing angle is greater than decreasing the voltage dividing proportion of the blue-white-balance (BWB) voltage.

8. The method according to claim 4, wherein, the blue-white-balance (BWB) voltage at 255th grayscale ranges from 4.5V to 7.1V.

9. A system for improving a color shift of viewing angle of skin color of an LCD screen, wherein, the system comprises a gamma curve acquisition unit, an adjustment unit, a comparing unit, and a voltage-dividing unit,
wherein the gamma curve acquisition unit obtains gamma curves of red (R), green (G), blue (B) and white (W) of front viewing angle of skin color picture of the LCD screen under a backlight;
wherein the adjustment unit for calculates an initial white balance voltage, the initial white balance voltage includes a red-white-balance (RWB) voltage, a green-white-balance (GWB) voltage and a blue-white-balance (BWB) voltage, and adjusting the gamma curves of red (R), green (G) and blue (B) of skin color picture of the LCD screen according to the initial white balance voltage;
wherein the gamma curve acquisition unit obtains gamma curves of red (R), green (G), blue (B) and white (W) of front viewing angle and oblique viewing angle of skin color picture of the LCD screen after adjusting according to the initial white balance voltage;
wherein the comparing unit compares the gamma curves and the chromaticity of 0-255 grayscale of front viewing angle and oblique viewing angle to obtain a color shift result of oblique viewing angle of skin color picture of the LCD screen; and
wherein the voltage-dividing unit changes a voltage dividing proportion of the blue-white-balance (BWB) voltage according to the color shift result to make a color shift value or oblique viewing angle of skin color picture of the LCD screen be always within a specification requirement.

10. The system according to claim 9, wherein, the voltage-dividing unit further comprises a red-voltage-dividing unit, a green-voltage-dividing unit, and a blue-voltage-dividing unit.
wherein, the red-voltage-dividing unit and the green-voltage-dividing unit respectively maintain the red-white-balance (RWB) voltage and the green-white-balance (RWB) voltage to be constant, and the blue-voltage-dividing unit correspondingly changes the voltage dividing proportion of the blue-white-balance (BWB) voltage according to the specification requirement in order to obtain a new white balance voltage;
wherein at the new white balance voltage, the comparing unit further obtains a color shift result of oblique viewing angle of skin color picture of the LCD screen to determine if the color shift result deviates from the specification requirement; and
wherein, if the color shift result deviates from the specifications, the blue-voltage-dividing unit repeatedly change the voltage dividing proportion of the blue-white-balance (BWB) voltage until at a new white balance voltage, the color shift value of oblique viewing angle of skin color picture of the LCD screen is always within specification requirement.

11. The system according to claim 9, wherein, the specification requirement is a color difference specification requirement between the front viewing angle and the oblique viewing angle, and the color difference specification requirement is that the color shift value of oblique viewing angle is within (−0.03, +0.03).

12. The system according to claim 11, wherein,
when the color shift value of oblique viewing angle is less than −0.03, the blue-voltage-dividing unit changes the blue-white-balance (BWB) voltage such that the voltage dividing proportion of the blue-white-balance (BWB) voltage becomes larger; and
when the color shift value of oblique viewing angle is greater than +0.03, the blue-voltage-dividing unit changes the blue-white-balance (BWB) voltage such that the voltage dividing proportion of the blue-white-balance (BWB) voltage becomes smaller.

13. The system according to claim 9, wherein, the blue-white-balance (BWB) voltage at 255th grayscale ranges from 4.5V to 7.1V.
